(19) United States
(12) Patent Application Publication
(10) Pub. No.: US 2025/0094660 A1
(43) Pub. Date: Mar. 20, 2025

(54) METHODS AND SYSTEMS OF DETERMINING THE STATIC STIFFNESS OF A BODY STRUCTURE

(71) Applicant: Siemens Industry Software NV, Leuven (BE)

(72) Inventor: Stefano Orlando, Bost (BE)

(21) Appl. No.: 18/714,366

(22) PCT Filed: May 19, 2022
(86) PCT No.: PCT/EP2022/063558

§ 371 Date: May 29, 2024

(30) Foreign Application Priority Data
Dec. 8, 2021 (EP) 21213175.9

(51) Int. Cl. G06F 30/15; G06F 111/10; G06F 119/14

(52) U.S. Cl. CPC G06F 30/15; G06F 2111/10; G06F 2119/14

(57) ABSTRACT

A method and system for determining the static stiffness of a body structure from dynamic data are disclosed. The method and system include providing dynamic data and defining flexible-body modes of the dynamic data of the body structure. To overcome the limitations of conventional methods and systems, the method and system further include: performing a modal decomposition of all defined flexible-body modes into contributions of rigid-body modes and a residual term. The modal decomposition of the body structure is defined as Formula (I), wherein Rⱼ is a residual term for the j^{th} flexible mode, such that the residual term results as free of inertial effects. The method and system further include determining the residual term Rⱼ from the modal decomposition and determining the static stiffness from the residual terms Rj.

The present patent document is a § 371 nationalization of PCT Application Serial No. PCT/EP2022/063558, filed May 19, 2022, designating the United States, and this patent document also claims the benefit of European Patent Application No. 21213175.9, filed Dec. 8, 2021, which are incorporated by reference in their entireties.

### TECHNICAL FIELD

The disclosure relates to a method of determining the static stiffness of a body structure from dynamic data, (e.g., of a vehicle body). The method includes providing dynamic data and defining flexible-body modes of the dynamic data of the body structure. The disclosure further relates to a system configured to perform the methods described herein.

### BACKGROUND

With the ongoing shift towards electrified mobility, automotive OEMs are spending significant efforts in the development of scalable platforms for their electric vehicles. These body structures for electric vehicles enable to underpin various vehicle models, like an SUV or sedan, as well as the integration of specific eDriveline layouts and battery packs.

This requires a dedicated (virtual) development process based on well-defined targets. For example, an eMotor will introduce significant quasi-static loads to the body structure, necessitating clear static stiffness targets for this structure.

Inertia relief is a widely applied method that enables to simulate unconstrained structures in a static analysis. One example in which this may be used is an object in flight, e.g., a body submerged in water. In case this body moves, the gravity-load is unbalanced with the buoyancy force. Applying an inertia relief loading exactly balancing these forces and puts the body into static equilibrium.

Inertia relief loading is a general concept applicable to any body structure for strength analysis. This analysis does not require the model to be constrained in all directions as finite element method would require. During a subsequent dynamic analysis, the inertia relief loading may be applied to the body as an additional force. The dynamic analysis then provides the transient response of the body to the dynamic loading as a deformation of the body relative to its static equilibrium position.

Another commonly known concept is the so called ‘static-from-dynamic’ approach. This approach acquires free-free transfer functions and is used to build a modal model from which the static stiffness characteristics are extracted (see, e.g., Trimmed Body Static Stiffness Identification Using Dynamic Measurements: Test Methodology and Correlation with CAE Results; ISSN: 0148-7191, e-ISSN: 2688-3627; DOI: https://doi.org/10.4271/2018-01-1496; Published Jun. 13, 2018 by SAE International in United States).

Inertia Relief and Static-from-Dynamic are widely used methods to enable static stiffness calculation.

These methods may be advantageous to static testing and simulation because their results do not depend on the clamping conditions of the car body. In the case of the Static-from-Dynamic, the free boundary conditions are easy to realize in test as well as in Computer-aided engineering [CAE].

During the development of a new vehicle engineers need to evaluate the body performances at different stages by comparing the results to predefined targets. It is general practice to set and evaluate targets at body-in-white (BiW) level first and to compare those to the ones defined at trimmed bodies (TB) level.

The evolution of the vehicle performances from BiW to TB is key to provide that the targets are met. Hence, the need of evaluating and comparing both in test as well as in simulation BiW and TB static stiffness.

Although widely used, both Inertia Relief and Static-from-Dynamics show limitations in effectively removing the inertial effects from the dynamic characteristics. Hence, the stiffness values calculated with these methods may be inaccurate, leading to large stiffness underestimations of TB models (e.g., both CAE as well as Test based) up to a factor 6. This blocks automotive OEMs to follow an objective target setting and tracking process as targets on BiW level may not be compared to results on TB level, resulting in a longer development time and a higher development cost.

### SUMMARY

With this disclosure, a methodology has been developed that overcomes the above limitations and enables accurate static stiffness calculation from dynamic data.

The scope of the present disclosure is defined solely by the appended claims and is not affected to any degree by the statements within this summary. The present embodiments may obviate one or more of the drawbacks or limitations in the related art.

In accordance with the disclosure, a solution is provided for the above-described problems by the defined method that includes: performing a modal decomposition of all defined flexible-body modes into contributions of rigid-body modes and a residual term (for each j exactly one resudual term). The modal decomposition of the body structure is defined as:

$${Ψ}_{Flex , j} = {\sum }_{i = 1}^{ó} {α}_{i j} {Ψ}_{RB , i} + {R}_{j}$$

wherein:
Ψ_{Flex, j} is the j^{th} flexible-body mode;
Ψ_{RB, i} is the i^{th} rigid-body mode;
αᵢⱼ are the decomposition factors of j^{th} flexible-body mode into rigid-body mode i;
Rⱼ is a residual term for the j^{th} flexible mode, such that the residual term results as free of inertial effects.

The method further includes determining the residual terms Rⱼ from the modal decomposition and determining the static stiffness from the residual terms Rⱼ.

The acts of performing a modal decomposition, determining the residual terms, and determining the static stiffness may be automized, controlled by a computer, or completely computer implemented.

In certain examples, modes or mode shapes may be divided into two categories: (1) rigid body modes and (2) flexible modes.

Rigid body modes do not involve any deformation of the part analyzed. The rigid body modes relate to the movement of the rigid body only, meaning translation and rotation. The flexible modes refer to the deformation of the part. Dynamic data may be derived from measurement with sensors, simulation results including virtual sensor measurements, or a combination thereof. This simulation may be a computer-implemented method act.

In case the dynamic data is obtained from measurements, the measuring process may be done via a measurement data acquisition unit may include an interface to a system for carrying out the method. The data acquisition may be automized and/or controlled by a computer.

The dynamic data may include vibration amplitudes and frequencies and/or of eigenvalues, eigenvectors of vibration.

According to an embodiment, the decomposition factors αᵢⱼ may be calculated by a pseudo-inverse operation:

$${Ψ}_{Flex , j} = {Q}_{F l e {x}_{j} , RBM} \times {Ψ}_{RBM}$$

$${Q}_{{Flex}_{j} , RBM} = {Ψ}_{Flex , j} \times INV ( {Ψ}_{RBM} )$$

where:
Q_{Flexj, RBM} is the j^{th} raw of the decomposition factors matrix that contains all 6 αⱼ factors;

$${Ψ}_{Flex , j}^{R} = {Q}_{F l e {x}_{j} , RBM} \times {Ψ}_{RBM} \neq {Ψ}_{Flex , j}$$

$${R}_{j} = {Ψ}_{Flex , j} - {Ψ}_{Flex , j}^{R}$$

where:
Ψ_{Flex, j}^{R} is the recombined j^{th} body structure flexible mode, which is the best possible approximation of the original vector using the body structure rigid body modes; and
Rⱼ is the j^{th} residual, which is the flexible j^{th} body structure mode with no residual inertial content.

Alternatively, the decomposition factors αᵢⱼ are calculated for each j by a least squares algorithm to minimize S wherein S being defined as:

$${R}_{j} = {Ψ}_{Flex , j} - f ( {α}_{ij} , {Ψ}_{RBM , i} )$$

$$S = {\sum }_{i = 1}^{j} {R}_{j}^{2}$$

From the residual term determined by dynamic mode decomposition, the stiffness may be determined as outlined below. The stiffness may also be termed dynamic stiffness due to its origin from dynamic data.

The general formulation of the stiffness matrix for a linear system, which is a suitable assumption resulting in adequate accuracy, may be provided as the following:

$$[ F ] = [ C ] * [ S ]$$

wherein:
[F]=force vector;
[S]=displacement vector; and
[C]=stiffness matrix.

The force vector may be defined for a number N of input points, in the below formulations respectively indicated with “j,” meaning a generic input point. Hence, Fⱼ is an element of the matrix [F].

The displacement vector may be defined for a number M of evaluation points herein indicated with “i” as a generic output point. Hence, Sᵢ is an element of the matrix [S]. Consequently, the stiffness tensor [C] respectively Cᵢⱼ has the dimension N*M:

$${C}_{i j} = \frac{1}{( {\sum }_{n = 1}^{N} ( \frac{{Q}_{n} {R}_{i n} {R}_{j n}}{j ω - {λ}_{n}} + \frac{{( {Q}_{n} {R}_{i n} {R}_{j n} )}^{*}}{j ω - {( {λ}_{n} )}^{*}} ) ) {F}_{j} ( ω )} for ω \to 0$$

Concerning these global modal parameters expression, it may be said that:
λₙ is the pole “n” of the eigenvalue analysis solution (in modal analysis). It may be expressed as σₙ+jωₙ, wherein σₙ is the real part of the pole and represents the damping factor, and wherein ωₙ is the imaginary part and represents the damped natural frequency.
Qₙ is the modal scaling factor for mode “n.”
Rⱼₙ is a residual term for the n^{th} flexible mode at load input point ‘j’ free of inertial effects.
Rᵢₙ is a residual term for the n^{th} flexible mode at evaluation point ‘i’ free of inertial effects.

The above explained global modal parameters include complex expressions wherein “j” is the imaginary unit. The imaginary unit is commonly indicated with the letter “j” or “i” as well and it is defined as j²=−1.

The stiffness tensor [C] or Cᵢⱼ may represent the stiffness of a linear system. The indexing here means that an excitation may be performed at point j and measured at point i. In case multiple excitation points are impacted, the stiffness tensor will include corresponding terms and the total stiffness will be a linear combination of those terms (linearity principle).

The residual term Rj, which cannot be represented by rigid-body-structure mode from the mode decomposition, may be filtered or free from inertial effects.

A mode may be understood as a displacement without a physical dimension. The modes may be expressed as a combination of eigenvectors and eigenvalues. As outlined, the mode may be used for static stiffness calculation. The mode may be represented as a linear combination of eigenvectors. Each mode contributes to the stiffness by a modal participation factor.

The acts for determination of the stiffness may be automized, controlled by a computer, or completely computer implemented.

Further, the disclosure relates to a system for carrying out the method as explained herein.

A system for performing any computer implemented act of a method according to the disclosure includes at least one computer including a processor. These acts may be executed directly on a CPU or performed by a virtual machine. A distribution of parts of the process over a network of cooperatively linked processes may be done advantageously. Such may be implemented using a network of computers.

### BRIEF DESCRIPTION OF THE DRAWINGS

Embodiments of the disclosure are now described, by way of example only, with reference to the accompanying drawings, of which:

FIG. 1 depicts a simplified flow diagram illustrating an example of a method as well as an example of a system for performing the method.

FIG. 2 depicts a simplified flow diagram illustrating an example of an alternative method of modal decomposition for determining a residual term for a n^{th} flexible mode.

The illustration in the drawings is in schematic form.

It is noted that in different figures, similar or identical elements may be provided with the same reference signs.

### DETAILED DESCRIPTION

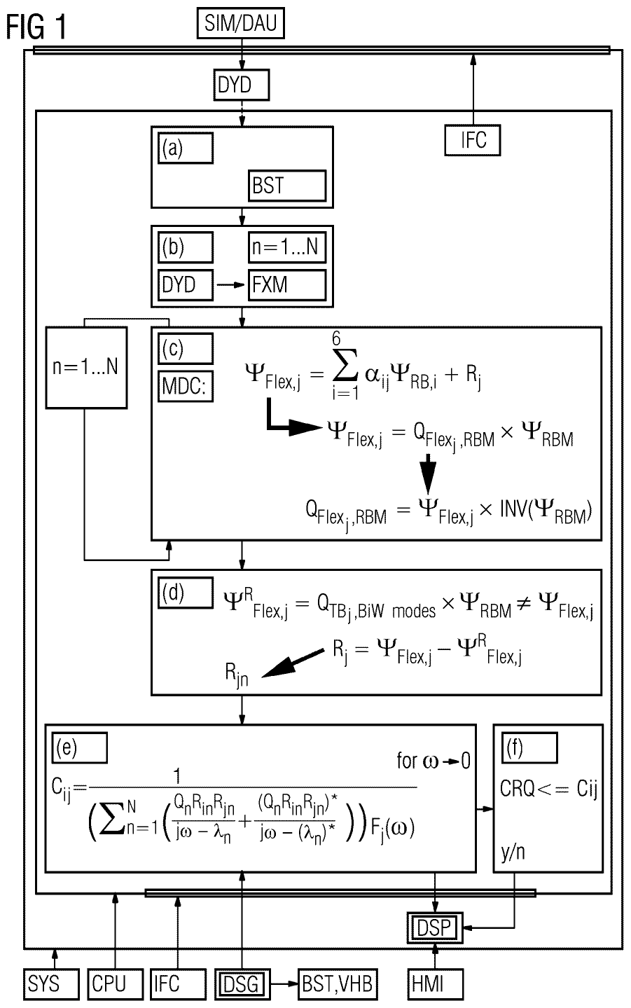

FIG. 1 shows a simplified flow diagram illustrating a method of determining the static stiffness Cij of a body structure BST from dynamic data DYD according to the disclosure. The body structure BST in an application may be a vehicle body VHB.

Further, FIG. 1 illustrates a system SYS for determining the static stiffness CIJ of a body structure BST which is prepared to perform the method. The system SYS including at least one processor CPU may be prepared by upload of computer-executable code to perform the method.

During act (a), dynamic data DYD is provided. This dynamic data DYD may include vibration amplitudes and frequencies and/or of eigenvalues, eigenvectors of vibration.

The dynamic data DYD may be obtained from measurement with sensors (these may include virtual sensors, too) or via a simulation SIM. In case the dynamic data is obtained from measurements, the measuring process may be done via a measurement data acquisition unit DAU may include an interface IFC to the system for carrying out the method to determine and maybe assess or evaluate and/or output the stiffness of the body structure. The stiffness may be used in a design process to evaluate the mechanical integrity of the body structure to improve or even optimize the design, e.g., by iteration of design changes and stiffness assessments.

During act (b), flexible-body modes FXM of the dynamic data DYD of the body structure BST are defined. The number of flexible-body modes FXM corresponds to the degree of freedom of the body structure BST.

In act (c), a modal decomposition of all defined flexible-body modes FXM into contributions of rigid-body modes and a residual term is performed. The modal decomposition MDC of the body structure BST is defined as:

$${Ψ}_{Flex , j} = {\sum }_{i = 1}^{6} {α}_{i j} {Ψ}_{RB , i} + {R}_{j}$$

wherein:
Ψ_{Flex, j} is the j^{th} flexible-body mode;
Y_{RB, i} is the i^{th} rigid-body mode;
αᵢⱼ are the decomposition factors of j^{th} flexible-body mode into rigid-body mode i; and
Rⱼ is a residual term for the j^{th} flexible mode, the residual term result as being free of inertial effects.

The decomposition factors αᵢⱼ are calculated by a pseudo-inverse operation:

$${Ψ}_{F lex , j} = {Q}_{{Flex}_{j} , RBM} \times {Ψ}_{RBM}$$

$${Q}_{{Flex}_{j} , RBM} = {Ψ}_{F lex , j} \times INV ( {Ψ}_{RBM} )$$

Here, Q_{Flexj, RBM} is the j^{th} raw of the decomposition factors matrix that contains all 6 αⱼ factors.

$${Ψ}_{Flex , j}^{{R}_{}} = {Q}_{{Flex}_{j} , RBM} \times {Ψ}^{RBM} \neq {Ψ}_{Flex , j}$$

$${R}_{j} = {Ψ}_{Flex , j} - {Ψ}_{Flex , j}^{R}$$

where:
Ψ_{Flex, j}^{R} is the recombined j^{th} body structure flexible mode, wherein this mode is the best possible approximation of the original vector using the body structure rigid body modes; and

Rⱼ is the j^{th} residual, wherein this is the flexible j^{th} body structure mode with no residual inertial content.

The result of act (c) is the decomposition factors αᵢⱼ enabling the determination of the residual term Rⱼₙ during act (d).

During act (e), the static stiffness Cij from the residual terms (Rⱼ) is determined as:

$${C}_{i j} = \frac{1}{( {\sum }_{n = 1}^{N} ( \frac{{Q}_{n} {R}_{in} {R}_{jn}}{j ω - {λ}_{n}} + \frac{{( {Q}_{n} {R}_{i n} {R}_{j n} )}^{*}}{j ω - {( {λ}_{n} )}^{*}} ) ) {F}_{j} ( ω )} for ω \to 0$$

wherein:
λₙ=σₙ+jωₙ is a pole of mode n of an eigenvalue analysis solution, where σₙ is the real part of the pole and represents the damping factor while ωₙ is the imaginary part and represents the damped natural frequency;
Qₙ is a modal scaling factor for mode n;
j is the imaginary unit;
N is the number of eigenmodes;
ω is the frequency of vibration;
Rⱼₙ is a residual term for the n^{th} flexible mode at load input point j free of inertial effects; and
Rᵢₙ is a residual term for the n^{th} flexible mode at evaluation point i free of inertial effects.

In a further act, the method may assess the sufficiency of the static stiffness Cij by comparing with a static stiffness requirement CRQ. The result of the comparison may be output via an interface IFC to a design process DSG and/or a human machine interface HMI, in particular, a display DSP.

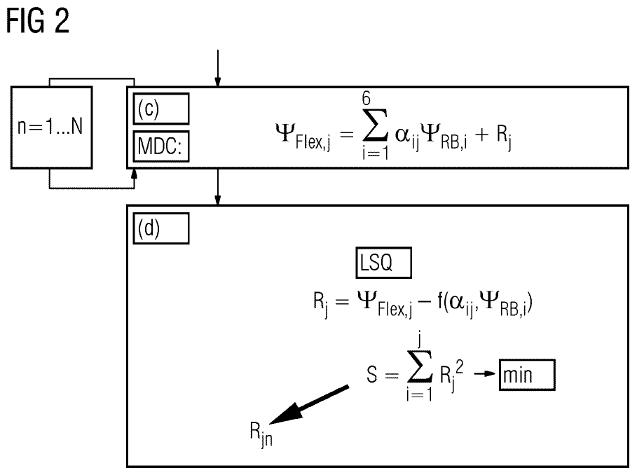

FIG. 2 illustrates an alternative determination of the residual term in acts (c) and (d). The decomposition factors α_ij are calculated by a least squares algorithm to minimize S as defined by:

$${R}_{j} = {Ψ}_{Flex , j} - f ( {α}_{ij} , {Ψ}_{RBM , i} )$$

$$S = {\sum }_{i = 1}^{j} {R}_{j}^{2}$$

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of determining a static stiffness of a body structure from dynamic data, the method comprising:
providing dynamic data;
defining flexible-body modes of the dynamic data of the body structure;
performing a modal decomposition of all defined flexible-body modes into contributions of rigid-body modes and a residual term, wherein the modal decomposition of the body structure is defined as:
$${Ψ}_{Flex , j} = {\sum }_{i = 1}^{6} {α}_{i j} {Ψ}_{RB , i} + {R}_{j}$$
wherein:
Ψ_{Flex, j} is a j^{th} flexible-body mode;
Ψ_{RB, i} is an i^{th} rigid-body mode;
αᵢⱼ are decomposition factors of j^{th} flexible-body mode into rigid-body mode i; and
Rⱼ is a residual term for the j^{th} flexible mode,
such that the residual term results as free of inertial effects;
determining residual terms from the modal decomposition; and
determining the static stiffness from the residual terms.

2. The computer-implemented method of claim 1, wherein the static stiffness is determined as:
$${C}_{i j} = \frac{1}{( {\sum }_{n = 1}^{N} ( \frac{{Q}_{n} {R}_{in} {R}_{jn}}{j ω - {λ}_{n}} + \frac{{( {Q}_{n} {R}_{in} {R}_{jn} )}^{*}}{j ω - ( {λ}_{n} ) {*}^{}} ) ) {F}_{j} ( ω )} for ω \to 0$$
wherein:
80 ₙ=σₙ+jΨₙ is a pole of mode n of an eigenvalue analysis solution, wherein σₙ is a real part of the pole and represents a damping factor, and wherein ωₙ is an imaginary part and represents a damped natural frequency;
Qₙ is a modal scaling factor for mode n;
j is an imaginary unit;
N is a number of eigenmodes;
ω is a frequency of vibration;
Rⱼₙ is a residual term for an n^{th} flexible mode at load input point j free of inertial effects; and
Rᵢₙ is a residual term for an n^{th} flexible mode at evaluation point i free of inertial effects.

3. A method of assessment of sufficiency of static stiffness of a body structure, the method comprising:
defining a static stiffness requirement;
determining the static stiffness via a computer-implemented process;
comparing the static stiffness requirement with the determined static stiffness; and,
outputting a result of the comparison via an interface to a design process and/or a human machine interface,
wherein the determining of the static stiffness via the computer-implemented process comprises:
providing dynamic data;
defining flexible-body modes of the dynamic data of the body structure;
performing a modal decomposition of all defined flexible-body modes into contributions of rigid-body modes and a residual term, wherein the modal decomposition of the body structure is defined as:
$${Ψ}_{Flex , j} = {\sum }_{i = 1}^{6} {α}_{ij} {Ψ}_{RB , i} + {R}_{j}$$
wherein:
Ψ_{Flex, j} is a j^{th} flexible-body mode;
Ψ_{RB, i} is an i^{th} rigid-body mode;
αᵢⱼ are decomposition factors of j^{th} flexible-body mode into rigid-body mode i; and
Rⱼ is a residual term for the j^{th} flexible mode,
such that the residual term results as free of inertial effects; determining residual terms from the modal decomposition; and determining the static stiffness from the residual terms.

4. A system configured to determine a static stiffness of a body structure, the system comprising:
at least one processor configured to:
receive dynamic data;
define flexible-body modes of the dynamic data of the body structure;
perform a modal decomposition of all defined flexible-body modes into contributions of rigid-body modes and a residual term, wherein the modal decomposition of the body structure is defined as:
$${Ψ}_{Flex , j} = {\sum }_{i = 1}^{6} {α}_{ij} {Ψ}_{RB , i} + {R}_{j}$$
wherein:
Ψ_{Flex, j} is a j^{th} flexible-body mode;
Ψ_{RB, i} is an i^{th} rigid-body mode;
αᵢⱼ are decomposition factors of j^{th} flexible-body mode into rigid-body mode i; and
Rⱼ is a residual term for the j^{th} flexible mode,
such that the residual term results as free of inertial effects; determine residual terms from the modal decomposition; and determine the static stiffness from the residual terms.

5. The system of claim 4, wherein the static stiffness is determined as:
$${C}_{i j} = \frac{1}{( {\sum }_{n = 1}^{N} ( \frac{{Q}_{n} {R}_{in} {R}_{jn}}{j ω - {λ}_{n}} + \frac{{( {Q}_{n} {R}_{in} {R}_{jn} )}^{*}}{j ω - ( {λ}_{n} ) {*}^{}} ) ) {F}_{j} ( ω )} for ω \to 0$$
wherein:
λₙ=σₙ+jωₙ is a pole of mode n of an eigenvalue analysis solution, wherein σₙ is a real part of the pole and represents a damping factor, and wherein ωₙ is an imaginary part and represents a damped natural frequency;
Qₙ is a modal scaling factor for mode n;
j is an imaginary unit;
N is a number of eigenmodes;
ω is a frequency of vibration;
Rⱼₙ is a residual term for an n^{th} flexible mode at load input point j free of inertial effects; and
Rᵢₙ is a residual term for an n^{th} flexible mode at evaluation point i free of inertial effects.

6. The system of claim 4, wherein the body structure is a body structure of a vehicle body.

7. The computer-implemented method of claim 1, wherein the body structure is a body structure of a vehicle body.

8. The method of claim 3, wherein the body structure is a body structure of a vehicle body.

9. The method of claim 3, wherein the static stiffness is determined as:
$${C}_{i j} = \frac{1}{( {\sum }_{n = 1}^{N} ( \frac{{Q}_{n} {R}_{i n} {R}_{j n}}{j ω - {λ}_{n}} + \frac{{( {Q}_{n} {R}_{i n} {R}_{j n} )}^{*}}{j ω - ( {λ}_{n} ) {*}^{}} ) ) {F}_{j} ( ω )} for ω \to 0$$
wherein:
λₙ=σₙ+jωₙ is a pole of mode n of an eigenvalue analysis solution, wherein σₙ is a real part of the pole and represents a damping factor, and wherein ωₙ is an imaginary part and represents a damped natural frequency;
Qₙ is a modal scaling factor for mode n;
j is an imaginary unit;
N is a number of eigenmodes;
ω is a frequency of vibration;
Rⱼₙ is a residual term for an n^{th} flexible mode at load input point j free of inertial effects; and
Rᵢₙ is a residual term for an n^{th} flexible mode at evaluation point i free of inertial effects.
